(19) United States
(12) Patent Application Publication
(10) Pub. No.: US 2003/0035106 A1
(43) Pub. Date: Feb. 20, 2003

(54) Phase-shifting alignment system

(76) Inventors: Chin-Te Yeh, Taipei (TW); Pao-Chih Chen, Yunlin Hsien (TW)

Correspondence Address: BIRCH STEWART KOLASCH & BIRCH, PO BOX 747, FALLS CHURCH, VA, 22040-0747, US

(21) Appl. No.: 09/928,370

(22) Filed: Aug. 14, 2001

(51) Int. Cl. G01B 11/00

(52) U.S. Cl. 356/400

(57) ABSTRACT

A phase-shifting alignment system for aligning a wafer in a stepper comprises a light source emitting a beam with a wavelength; a plurality of grating stripes formed on the wafer, wherein when the beam from the light source is incident upon the grating stripes, the wafer reflects a diffraction beam; a filter unit positioned on the optical path of the diffraction beam, such that the diffraction beam travels through the filter unit so as to generate a convolution beam; a positive lens having a front focal length, a back focal length and an optical axis and positioned on the optical path of the convolution beam so as to generate Fourier transform of the convolution beam at the back focal length, wherein the distance between the positive lens and the filter unit is the front focal length; and an image-receiving means positioned at the back focal length of the lens so as to receive the Fourier transform of the convolution beam on the optical axis of the lens.

### BACKGROUND OF THE INVENTION

1. Field of the Invention

The invention relates to a phase-shifting alignment system, and more particularly to the alignment of a wafer in a lithography machine by utilizing the phase-shifting alignment system.

2. Description of the Related Art

In the prior art, a wafer-bearing plate carries a wafer, and moves in a lithography machine. An alignment mark in the shape of a cross or stripes is preformed on the wafer. As shown in FIG. 1, a conventional alignment system includes a light source 1, several lenses 2, a spatial filter 3, several filters 4a, 4b, a prism 5, a lens 6, an erector 7, and a camera (that is a CCD camera) 8; wherein several lenses 2 have a front-illuminated lens group 2a, a back-illuminated lens group 2b and a relay lens 2c. The light emitted from the light source 1, such as a fiber, is uniformly illuminated on the spatial filter 3 after passing the front-illuminated lens group 2a. After a spatial pattern generated from the spatial filter 3 passes the back-illuminated lens group 2b, it is reflected by the prism 5. Next, the spatial pattern is projected on a predetermined alignment position by the lens 6. When a wafer 9 carried by a wafer-bearing plate moves to the predetermined alignment position in the lithography machine, the spatial pattern of the cross/stripes shape is formed on the wafer 9. Next, the spatial pattern of the cross/stripes shape on the wafer 9 is reflected into the lens 6, and then passes the relay lens 2c and the erector 7 after reflecting by the prism 5. Finally, the camera 8 receives the spatial pattern of the cross/stripes shape on the wafer 9. When the camera 8 receives a clear cross/stripes shaped spatial pattern, the wafer 9 is located at the best exposure position.

When the line width of a semiconductor device narrows, the line width of the spatial pattern of the cross/stripes shape for aligning the wafer also narrows. However, the resolution of the CCD in the camera is fixed. Therefore, when the line width of a semiconductor device narrows, the line density of the stripes/cross is increased. When the line density of the stripes/cross is greater than the resolution of the CCD, the CCD can not obtain a clear pattern of the stripes/cross shape. Therefore, the wafer is not always located at the best exposure position.

### SUMMARY OF THE INVENTION

To solve the above problems, it is an object of the present invention to provide a phase-shifting alignment system including a light source, a beam splitter, a filter, a lens, and an image-receiving device.

A feature of the invention is to provide a periodic stripe, wherein the width between two alternate stripes is substantially equal to the wavelength of the light source.

Another feature of the invention is to provide a periodic stripe, wherein the length of each periodic stripe is equal to or greater than 30 times the width between two adjacent stripes.

Another feature of the invention is to provide a filter, wherein the filter has the properties of phase grating, amplitude splitting, phase shifting, and others.

### BRIEF DESCRIPTION OF THE DRAWINGS

This and other objects and features of the invention will become clear from the following description, taken in conjunction with the preferred embodiments with reference to the drawings, in which:

FIG. 1 schematically illustrates a conventional wafer alignment system;

FIG. 2 schematically shows the stripe pattern formed on the wafer in the embodiment of the invention;

FIG. 3 schematically shows the phase-shifting alignment system of the invention;

FIG. 4A schematically illustrates the phase grating effect of the filter A;

FIG. 4B schematically illustrates the amplitude splitting effect of the filter B;

FIG. 4C schematically illustrates the phase shifting effect of the filter C;

FIG. 4D schematically illustrates the composite effect of the B and C filters, which has the effect of combining amplitude splitting and phase shifting;

FIG. 5 schematically shows another phase-shifting alignment system of the invention.

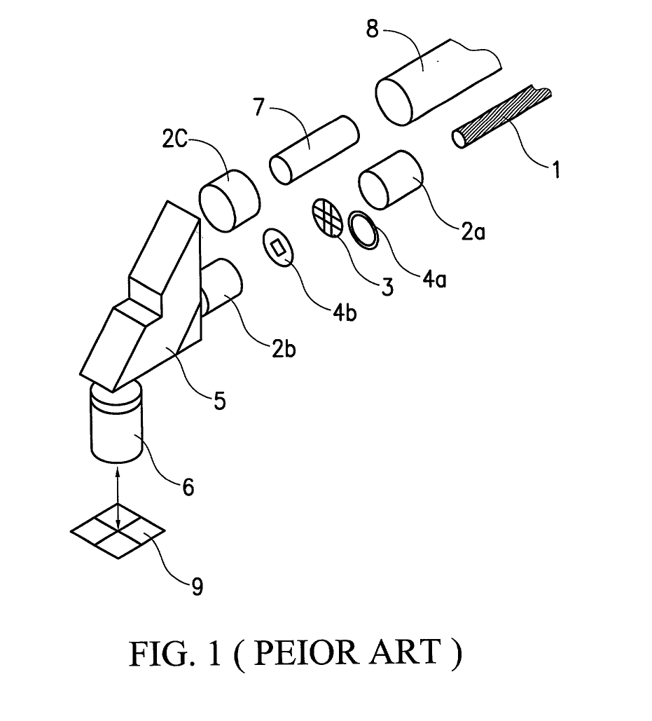

### DETAILED DESCRIPTION OF THE PREFERRED EMBODIMENTS

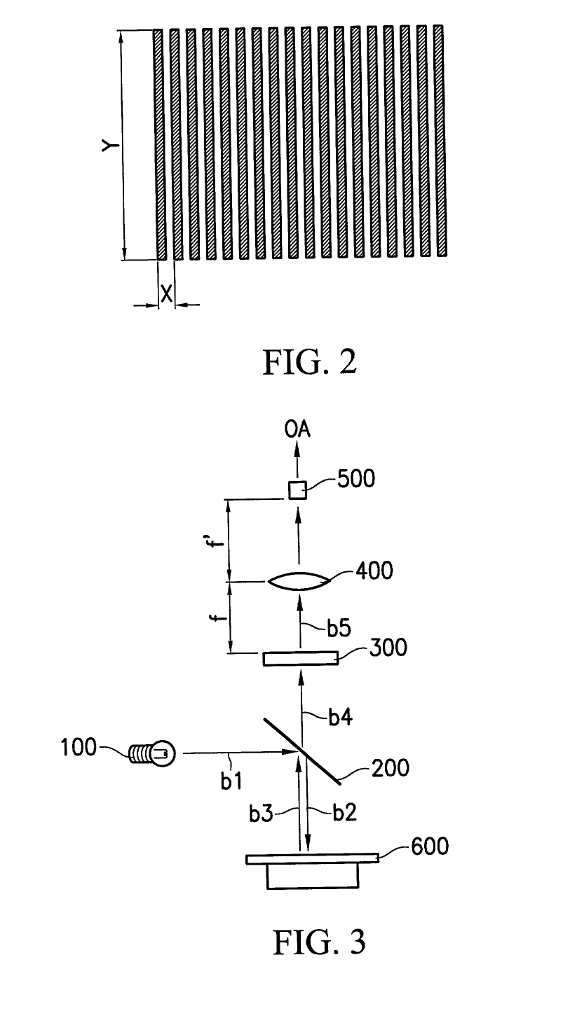

FIG. 2 schematically shows the stripe pattern formed on the wafer in the embodiment of the invention. As shown in FIG. 2, the stripes are arranged in the form of alternately bright and dark stripes or alternately deep and light stripes. The width X between two alternate stripes is equal to or greater than the wavelength of light illuminating the wafer. The ratio of the length Y of each stripe to the width X between two alternate stripes must satisfy the following condition:

Y/X≧30

Additionally, the periodic stripes can be described by the function of:

g(ξ, η)=(½)[1+2cos(2πfη+φ)]

wherein ξ represents the lengthways position of each stripe, η represents the lateral position of each stripe, φ represents the lateral distance between the optical axis and the stripe, and f represents the frequency of the periodic stripes.

FIG. 3 schematically shows the phase-shifting alignment system of the invention. As shown in FIG. 3, the phase-shifting alignment system includes a light source 100, a beam splitter 200, a filter unit 300, a lens 400 and an image-receiving means 500. As shown in FIG. 3, the beam b1 emitted from the light source 100 illuminates the beam splitter 200. Next, the beam b2 reflected by the beam splitter 200 is incident upon the grating stripes on the wafer 600. The grating stripes on the wafer 600 reflect the beam b2 and, when the wavelength of the light beam is substantially equal to the width of the two adjacent grating stripes, generate diffraction beam b3. The diffraction beam b3 reflected by the wafer surface 600 is incident upon the beam splitter 200 again. Next, the diffraction beam b4 passing through the beam splitter 200 travels through the filter unit 300 and generates convolution beam b5. The front focal length f of the above-mentioned lens 400 is substantially equal to its back focal length f′. When the distance between the filter unit 300 and the lens 400 is equal to the front focal length f, the lens 400 acts on the convolution beam b5 by the effect of Fourier transform of the lens 400. The lens 400 transforms the convolution beam b5 at the position of front focal length f into a transformation image at the position of back focal length f′ (see “Introduction to Fourier OPTICS”, pp. 108-112, 2^{nd} edition, (McGraw-Hill, New York) by Goodman) . That is, the lens 400 has an effect of Fourier transform to act on the convolution beam b5. Finally, the image-receiving means 500 is positioned at the back focal length f′ of the lens 400 so as to receive the transformation image.

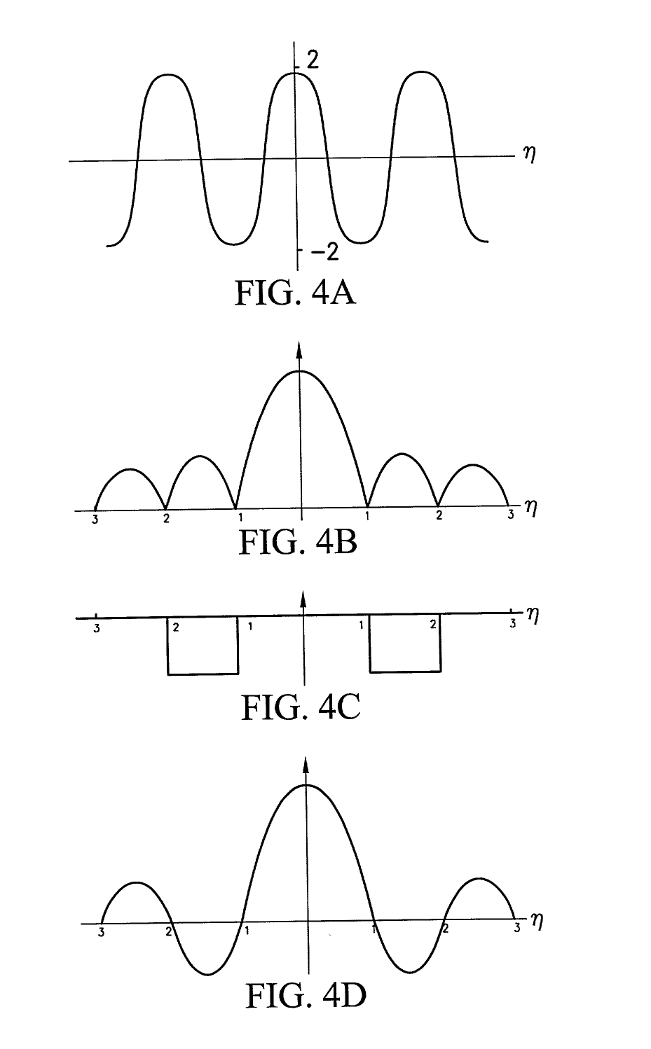

As shown in FIG. 4A to FIG. 4c, the filter unit of the invention has a composite effect by several filters. FIG. 4A shows a filter A with a phase grating effect. FIG. 4B shows a filter B with a phase amplitude effect. FIG. 4C shows a filter C with a phase shifting effect. Therefore, the filter unit 300 has the composite effect of combining filters A, B, and C.

As shown in FIG. 4A, the phase grating effect of the filter A has the same frequency as the periodic stripes. The effect of phase grating by the filter A can be expressed by the function of

m₁=2cos (2πfη)

As shown in FIG. 4B, the filter B has a phase amplitude effect laterally across the periodic stripes. In general, a wedge-shaped film is formed on the filter surface to create the phase amplitude effect. As shown in FIG. 4C, the filter C has a phase amplitude effect laterally across the periodic stripes. The initial phase angle of a light is transferred by the effect of phase shifting. For example, in the embodiment of the invention, the initial phase angle of a light is changed to 180° .

When the filter B is combined with the filter C, any beams traveling through the combined filters will experience the composite effects of phase amplitude and phase shifting. FIG. 4D schematically shows the convolution result of the beams traveling through the filter B of FIG. 4B and the filter C of FIG. 4C. As shown in FIG. 4D, the composite effects of phase amplitude and phase shifting can be expressed as a function of sinc(ξ, η).

Therefore, the filter unit 300, including filters A, B and C, provides the composite effects of phase grating, phase amplitude and phase shifting, a convolution result, and is expressed as a function of:

$$\begin{matrix}m ( ξ , η ) = sinc ( ξ , η ) * {m}_{1} \\ = sinc ( ξ , η ) * 2 cos ( 2 π f η ) \\ = sinc ( ξ , η ) * [ {ⅇ}^{j 2 π f η} + {ⅇ}^{- j 2 π f η} ] \\ = sinc ( ξ , η ) * {ⅇ}^{j 2 π f η} + sinc ( ξ , η ) * {ⅇ}^{- j 2 π f η} .\end{matrix}$$

After the diffraction beam reflected by the wafer surface travels through the filter unit and the lens, the transformation image at the back focal length f□ of the lens can be expressed as a function of:

F{g(ξ, η)}*F{m(ξ, η)}

=F{(½)×[1+2cos(2πfη+φ)]}*F{sinc(ξ, η)*e^{j2πfη}+sinc(ξ, η)e^{i-j2πfη}}

F{g(x, y)}*F{m(x, y)}

=½[δ(fx, fy−f)e^{-jφ}+δ(fx, fy+f)e^{jφ}]*[rect(fx, fy−f)+rect(fx, fy+f)]

Furthermore, the function of the transformation image can be divided into image on optical axis and image off optical axis. The image on optical axis can be expressed as a function of:

F{g(x, y)}*F{m(x, y)}

≈½[rect(fx, fy)e^{jφ}+rect (fx, fy)e^{-iφ}]+other higher order terms(/image off optical axis)

≈½[rect(fx, fy)+rect (fx, fy)e^{-jφ}]e^{jφ}+other higher order terms(/image off optical axis),

wherein

$$rect ( fx ) = \{ \begin{matrix}1 & \vert fx \vert \leq 1 / 2 \\ 0 & otherwise\end{matrix}$$

Because the image-receiving means 500 is positioned on the optical axis OA of the lens 400, the image-receiving means 500 only receives the image on optical axis, that is, image on optical axis by way of convolution of the filter unit and Fourier transform of the lens. Finally, the image-receiving means 500 receiving the image on optical axis provides two results.

If φ=π/2, the exponential terms are zero. In other words, F{g(ξ, η)}*F{m(ξ, η)}=0, and it means that after the diffraction beam is acted on the effects of convolution and Fourier transform, the amplitude of the light is reduced to zero. The intensity of the transformation image on optical axis is reduced to zero, so the image-receiving means receiving no images indicates that the alignment of the wafer is accomplished.

If φ≠π/2, the exponential terms are other than zero. The image-receiving means receiving images represents that the alignment of the wafer is unfinished.

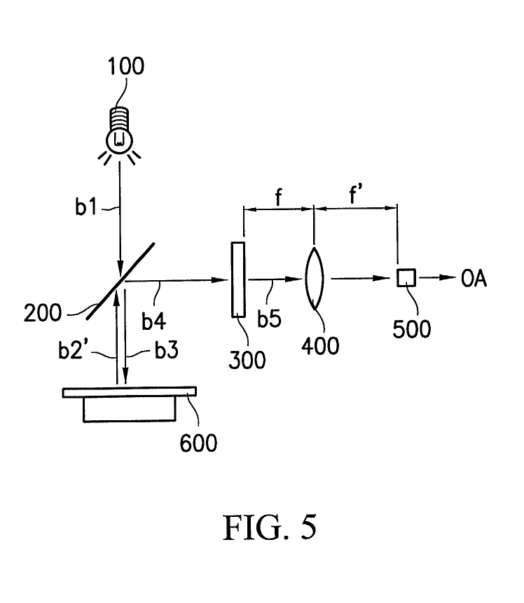

FIG. 5 schematically shows another phase-shifting alignment system of the invention. As shown in FIG. 5, the phase-shifting alignment system also includes a light source 100, a beam splitter 200, a filter unit 300, a lens 400 and an image-receiving means 500. As shown in FIG. 5, the beam b1 emitted from the light source 100 illuminates the beam splitter 200. Next, the beam b2′ passing through the beam splitter 200 is incident upon the grating stripes on the wafer 600. When the wavelength of the light beam is substantially equal to the width of the two adjacent grating stripes, the grating stripes on the wafer 600 reflect the beam b2′ and generate a diffraction beam b3. The diffraction beam b3 reflected by the wafer surface 600 is incident upon the beam splitter 200 again. Next, the diffraction beam b4 reflected by the beam splitter 200 travels through the filter unit 300 and generates convolution beam b5. The front focal length f of the above-mentioned lens 400 is substantially equal to its back focal length f′. When the distance between lens 400 is equal to the front focal length f, the lens 400 acts on the convolution beam b5 by the effect of Fourier transform of the lens 400. The lens 400 transforms the convolution beam b5 at the position of front focal length f into a transformation image at the position of back focal length f′. Finally, the image-receiving means 500 is positioned at the back focal length f′ of the lens 400 so as to receive the transformation image.

Furthermore, the front focal length and the back focal length of the double-convex lens can be different from each other in the embodiment of the invention. The light source of the alignment system and the light source of the stepper can be the same or different.

While the preferred embodiment of the present invention has been described, it is to be understood that modifications will be apparent to those skilled in the art without departing from the spirit of the invention. The scope of the invention, therefore, is to be determined solely by the following claims.

What is claimed is:

1. A phase-shifting alignment system for aligning a wafer in a stepper, comprising:
a light source emitting a beam with a wavelength;
a plurality of grating stripes formed on the wafer, wherein when the beam from the light source is incident upon the grating stripes, the wafer reflects a diffraction beam;
a filter unit positioned on the optical path of the diffraction beam, such that the diffraction beam travels through the filter unit so as to generate a convolution beam;
a positive lens having a front focal length, a back focal length and an optical axis and positioned on the optical path of the convolution beam so as to generate Fourier transform of the convolution beam at the back focal length, wherein the distance between the positive lens and the filter unit is the front focal length; and
an image-receiving means positioned at the back focal length of the lens so as to receive the Fourier transform of the convolution beam on the optical axis of the lens.

2. A phase-shifting alignment system as claimed in claim 1, wherein the length of each grating stripe is equal to or greater than 30 times the width between two adjacent stripes.

3. A phase-shifting alignment system as claimed in claim 1, wherein the width between two alternate stripes is substantially equal to the wavelength of the light source.

4. A phase-shifting alignment system as claimed in claim 1, wherein the grating stripes are described by the function of:
g(ξ, η)=(½)[1+2cos(290 fη+φ)]
wherein the ξ represents the lengthways position of each stripe, the η represents the lateral position of each stripe, φ represents the lateral distance between the optical axis and the stripe, and f represents the frequency of the grating stripes.

5. A phase-shifting alignment system as claimed in claim 1, wherein the filter unit further comprises the composite effects of phase grating, phase amplitude and phase shifting.

6. A phase-shifting alignment system as claimed in claim 1, wherein the filter unit is described by the function of:
m(ξ, η)=sinc(ξ, η)*e^{j2πfη}+sinc(ξ, η)*e^{-j2πfη}
wherein the ξ represents the lengthways position of each stripe, the η represents the lateral position of each stripe, and f represents the frequency of the grating stripes.

7. A phase-shifting alignment system as claimed in claim 1, wherein Fourier transform of the convolution beam on an optical axis received by the image-receiving means is described by the function of:
½[rect(fx, fy)+rect(fx, fy)e^{-j2φ}]e^{jφ}
wherein
$$rect ( fx ) = \{ \begin{matrix}1 & \vert fx \vert \leq 1 / 2 \\ 0 & otherwise\end{matrix} .$$

8. A phase-shifting alignment system as claimed in claim 1, further comprising a beam splitter positioned in front of the light source so as to divide the beam from the light source into a reflection beam and a transmission beam.

9. A phase-shifting alignment system as claimed in claim 8, wherein the reflection beam is incident upon the grating stripes.

10. A phase-shifting alignment system as claimed in claim 8, wherein the transmission beam is incident upon the grating stripes.
